(19) United States
(12) Patent Application Publication
(10) Pub. No.: US 2018/0362267 A1
(43) Pub. Date: Dec. 20, 2018

(54) APPARATUS FOR FEEDING SOLAR PANEL

(71) Applicant: DMS CO., LTD., Yongin-si (KR)

(72) Inventors: Yong Seok PARK, Seoul (KR); Gyoo Won SEO, Hwaseong-si (KR); Hee Won KIM, Seoul (KR); Min Shik KIM, Seoul (KR); Yun Kwang CHOI, Yongin-si (KR)

(73) Assignee: DMS CO., LTD., Yongin-si (KR)

(21) Appl. No.: 15/728,511

(22) Filed: Oct. 10, 2017

(30) Foreign Application Priority Data
Jun. 14, 2017 (KR) 10-2017-0074653

(51) Int. Cl. B65G 47/91; B25J 15/06

(52) U.S. Cl. CPC B65G 47/91; B65G 47/912; B25J 15/0616

(57) ABSTRACT

An apparatus for feeding a solar panel includes a picker section which holds a plurality of solar panels; a first feeding section which makes the picker section reciprocate in a vertical direction; and a second feeding section which makes the picker section reciprocate in a horizontal direction, wherein the picker section includes: a main rail arranged in the horizontal direction; a plurality of picker units provided under the main rail, reciprocating in a lengthwise direction of the main rail, and holding and moving corresponding solar panels at a time; a connecting unit connecting neighboring picker units among the picker units, and restricting a space between the neighboring picker units not to go beyond a preset reference space; and an adjusting unit provided on the main rail to make the picker units move in the lengthwise direction of the main rail and adjust a space between the picker units.

### CROSS-REFERENCE TO RELATED APPLICATION

This application claims priority from Korean Patent Application No. 10-2017-0074653, filed on Jun. 14, 2017 in the Korean Intellectual Property Office, the disclosure of which is incorporated herein by reference.

### BACKGROUND OF THE INVENTION

### (a) Field of the Invention

The present invention relates to an apparatus for feeding a solar panel, and more particularly to an apparatus for feeding a solar panel, by which a plurality of solar panels are fed at a time and arranged at regular intervals.

### (b) Description of the Related Art

In general, solar photovoltaic power generation refers to a power generation scheme that directly converts sunlight into electricity through a solar cell. The solar photovoltaic power generation has advantages that there is no need to worry about air pollution, noise, heat generation, vibration, etc.; there is no need to transport a fuel; less cost and effort are required for maintenance of power equipment; the power equipment has a long life; and it is easy to select a scale of equipment and install the equipment.

The solar photovoltaic power generation is achieved in the solar cell. The efficiency of the solar cell is varied depending on how efficiently a silicon wafer surface absorbs incident light. A collection of solar cells is called a solar battery, and the solar battery made into a panel is called a solar panel.

To improve the efficiency of the solar photovoltaic power generation, a plurality of solar panels is installed to be used as a solar module. In general, the solar module is manufactured by mounting the solar panels to a base plate and electrically connecting the respective solar panels.

By the way, to manufacture the solar module with the plurality of solar panels, an apparatus has been used for feeding the plurality of solar panels to a subsequent process.

As an example of a conventional apparatus for feeding the solar panel, there is a belt conveyer. That is, the solar panel is put on a belt being driven by a plurality of rollers, and thus conveyed. In this manner, the solar panel may be damaged since vibration is transferred from the rollers to the solar panel via the belt. To prevent or reduce this problem, the belt may be driven at a low speed for decreasing the vibration. However, a feeding speed for the solar panel is also decreased in this case.

### SUMMARY OF THE INVENTION

Accordingly, the present invention is conceived to solve the conventional problems, and an aspect of the present invention is to provide an apparatus for feeding a solar panel, by which a plurality of solar panels are fed at a time and arranged at regular intervals.

According to an aspect of the present invention, there is provided an apparatus for feeding a solar panel, including: a picker section which holds a plurality of solar panels; a first feeding section which makes the picker section reciprocate in a vertical direction; and a second feeding section which makes the picker section reciprocate in a horizontal direction, the picker section including: a main rail arranged in the horizontal direction; a plurality of picker units provided under the main rail, reciprocating in a lengthwise direction of the main rail, and holding and moving corresponding solar panels at a time; a connecting unit connecting neighboring picker units among the picker units, and restricting a space between the neighboring picker units not to go beyond a preset reference space; and an adjusting unit disposed on the main rail to make the picker units move in the lengthwise direction of the main rail and adjust a space between the picker units.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 is a perspective view of an apparatus for feeding a solar panel according to an embodiment of the present invention;

FIG. 2 is a perspective view of a picker section in the apparatus for feeding the solar panel according to an embodiment of the present invention;

FIG. 3 is a front view of the picker section in the apparatus for feeding the solar panel according to an embodiment of the present invention;

FIG. 4 is a perspective view of mainly showing a picker unit in the apparatus for feeding the solar panel according to an embodiment of the present invention;

FIG. 5 is an exploded perspective view of FIG. 4; and

FIG. 6 is an assembled view of the picker unit in the apparatus for feeding the solar panel according to an embodiment of the present invention.

### DETAILED DESCRIPTION OF THE EMBODIMENTS

Hereinafter, embodiments of an apparatus for feeding a solar panel according to the present invention will be described with reference to the accompanying drawings. The present invention is not limited or restricted by the following embodiments. Further, detailed descriptions of publicly known functions or structures may be omitted to make the gist of the present invention clear.

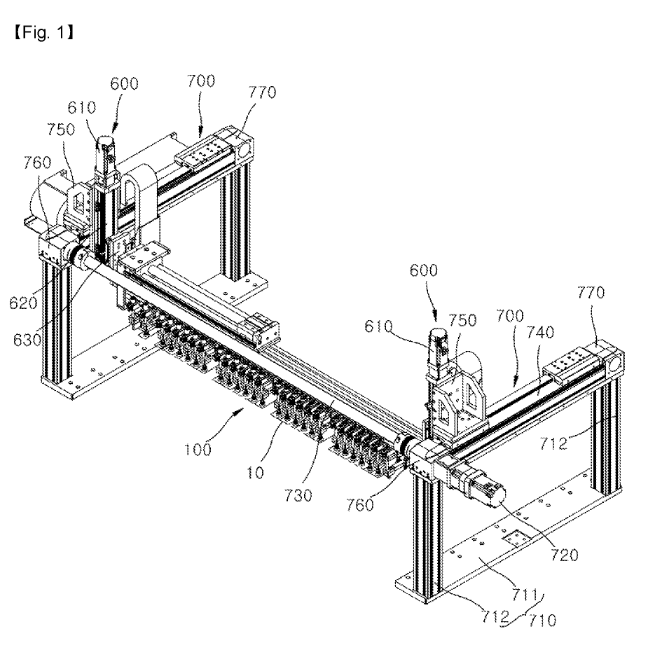

FIG. 1 is a perspective view of an apparatus for feeding a solar panel according to an embodiment of the present invention.

As shown in FIG. 1, the apparatus for feeding the solar panel includes a picker section 100, a first feeding section 600 and a second feeding section 700.

The picker section 100 may hold a plurality of solar panels 10.

The first feeding section 600 may include a first motor 610, a first guide frame 620 and a first mount 630.

The first motor 610 may generate power.

The first guide frame 620 may be placed under the first motor 610 and arranged in a vertical direction.

The first mount 630 may be provided in a lower end portion of the first guide frame 620.

The first feeding section 600 may be provided at opposite end portions of the picker section 100, and the opposite end portions of the picker section 100 may be coupled to the first mount 630. The first mount 630 may be driven by the power generated in the first motor 610 to reciprocate in a lengthwise direction of the first guide frame 620, and thus the picker section 100 can reciprocate in a vertical direction.

The second feeding sections 700 may form a pair being spaced apart from each other and each couple with the first feeding section 600.

The second feeding section 700 may include an installation frame 710, a second motor 720, a power transmitting shaft 730, a second guide frame 740 and a second mount 750.

The installation frame 710 may include a base frame 711, and a vertical frame 712 arranged at opposite sides of the base frame 711 in a vertical direction.

The second motor 720 may be provided in one of the vertical frames 712.

The power transmitting shaft 730 may connect with the pair of installation frames 710, and be driven to rotate by power from the second motor 720.

The second guide frame 740 may be connected in between upper end portions of the vertical frame 712. The second guide frame 740 may be arranged horizontally.

The second mount 750 may be provided in the second guide frame 740, and reciprocate in a lengthwise direction of the second guide frame 740. The second mount 750 may couple with the first feeding section 600.

Each second guide frame 740 may be provided with a first connecting box 760 and a second connecting box 770. Each first connecting box 760 may be internally provided with a first gear (not shown) rotated interlocking with the power transmitting shaft 730, and each second connecting box 770 may be provided with a second gear (not shown). Further, the first gear and the second gear may be connected by a belt (not shown). The belt may be placed inside the second guide frame 740, and arranged in a lengthwise direction of the second guide frame 740.

When the second motor 720 generates rotary power, the power transmitting shaft 730 rotates and the first gear rotates together with the power transmitting shaft 730, thereby rotating the belt. Therefore, the second mount 750 coupling with the belt can reciprocate in the lengthwise direction of the second guide frame 740, and the picker section 100 coupled to the first feeding section 600 together with the second mount 750 also reciprocate in the lengthwise direction of the second guide frame 740.

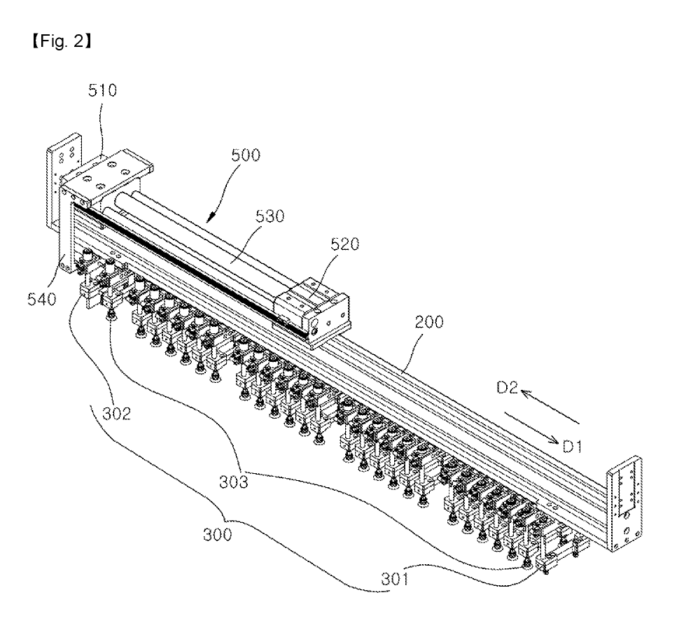

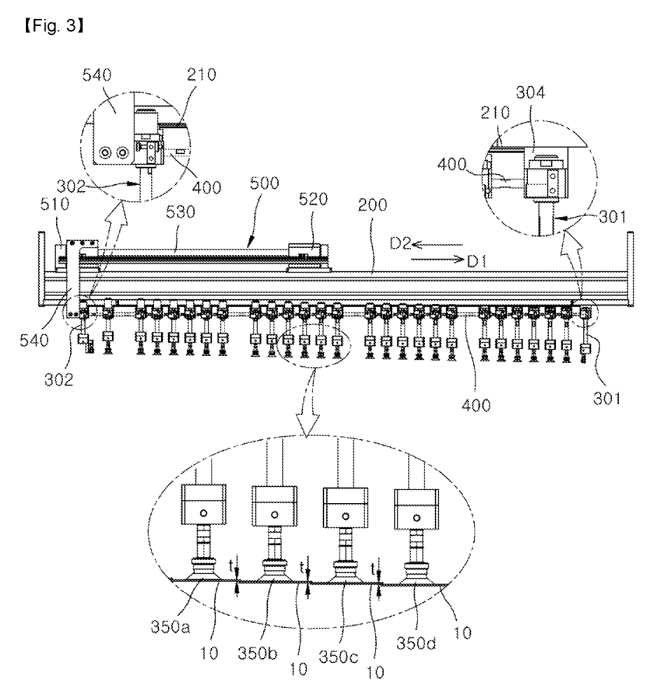

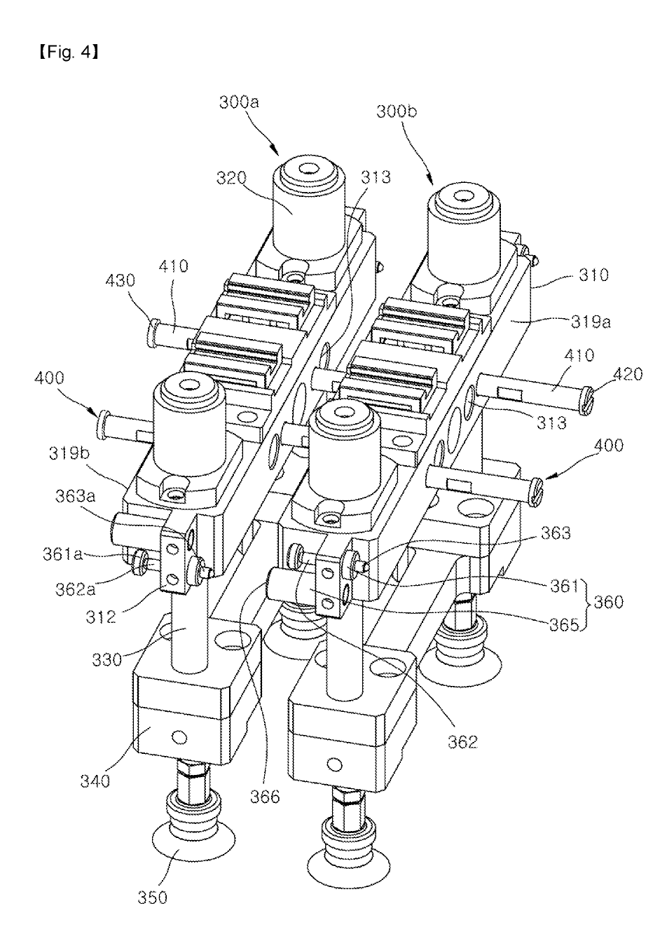

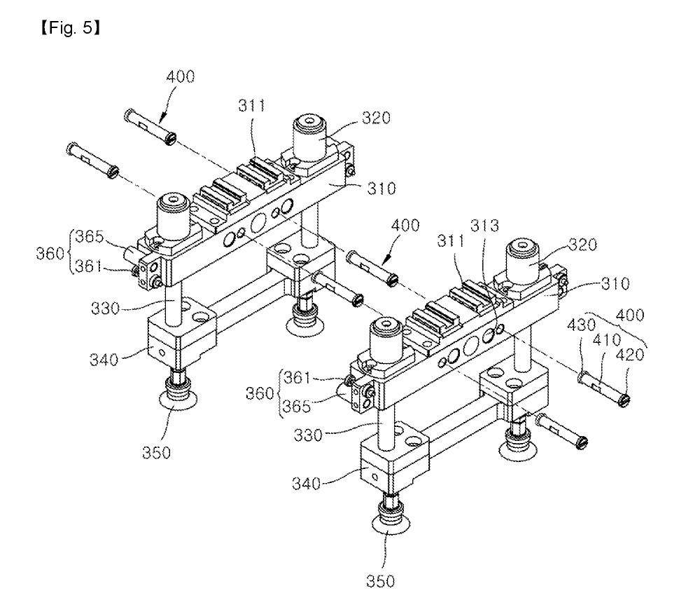

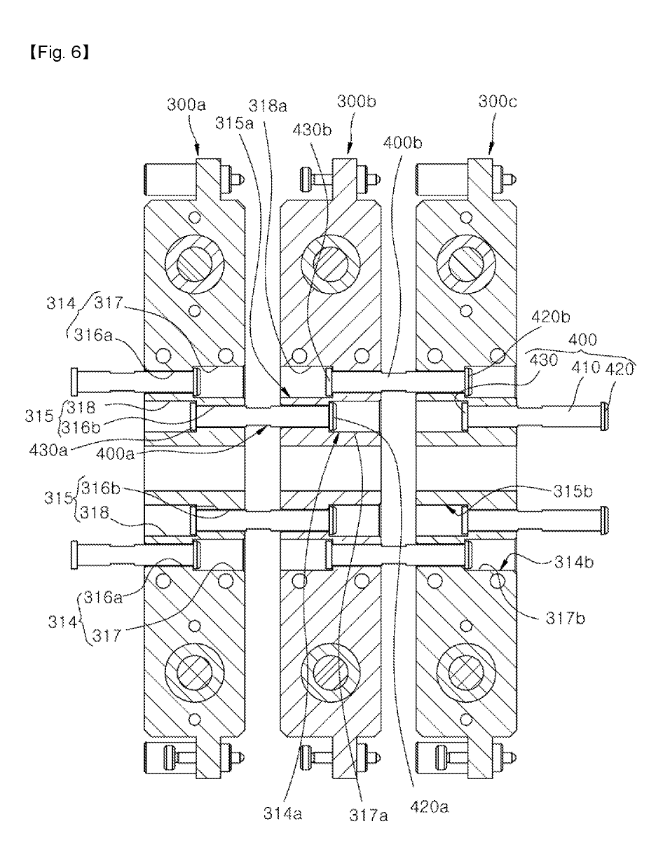

FIG. 2 is a perspective view of a picker section in the apparatus for feeding the solar panel according to an embodiment of the present invention, FIG. 3 is a front view of the picker section in the apparatus for feeding the solar panel according to an embodiment of the present invention, FIG. 4 is a perspective view of mainly showing a picker unit in the apparatus for feeding the solar panel according to an embodiment of the present invention, FIG. 5 is an exploded perspective view of FIG. 4, and FIG. 6 is an assembled view of the picker unit in the apparatus for feeding the solar panel according to an embodiment of the present invention.

As shown in FIG. 2 to FIG. 6, the picker section 100 may include a main rail 200, a picker unit 300, a connecting unit 400 and an adjusting unit 500.

The main rail 200 may connect with the first mount 630 (refer to FIG. 1), and may be arranged horizontally. The main rail 200 may include a plurality of guide rails 210 in a lower portion thereof in a lengthwise direction of the main rail 200.

The picker unit 300 may include a sliding block 310, a cylinder 320, a vertical tube 330, a supporting block 340 and a suction section 350.

The sliding block 310 may have a guide block 311 and a flange 312. The guide block 311 may be an upper portion of the sliding block 310. The guide block 311 may engage with the guide rail 210 and move along a lengthwise direction of the guide rail 210. Thus, the sliding block 310 may reciprocate in the lengthwise direction of the main rail 200. The sliding block 310 may be extended in a widthwise direction of the main rail 200. The flanges 312 may protrude at the opposite end portions of the sliding block 310. Further, the sliding block 310 may be formed with a plurality of coupling holes 313 in the lengthwise direction of the main rail 200.

The cylinder 320 may be provided at the opposite end portions of the sliding block 310. The cylinder 320 may provide vacuum pressure. The cylinder 320 may generate the vacuum pressure by itself, or receive the vacuum pressure generated from the outside.

The vertical tube 330 may connect with the cylinder 320, and may be extended downward in a vertical direction. The vertical tube 330 may form a passage through which the vacuum pressure from the cylinder 320 is transferred.

The supporting block 340 may be placed in a lower portion of the sliding block 310. The supporting block 340 may connect with a pair of vertical tubes 330 and may stably support the vertical tube 330. The supporting block 340 may be internally formed with a passage (not shown) through which the vacuum pressure from the vertical tube 330 is transferred.

The suction section 350 may be placed in a lower portion of the supporting block 340, and applies the vacuum pressure transferred from the supporting block 340. The suction section 350 may be attached to a top surface of the solar panel 10 and hold the solar panel 10 by the vacuum pressure.

The connecting unit 400 may couple with the coupling hole 313 formed in the sliding block 310.

The connecting unit 400 may include a body 410, a first locking portion 420 and a second locking portion 430.

The body 410 may be inserted in the coupling holes of the neighboring picker units and connect the neighboring picker units.

The first locking portion 420 may be formed at a first end portion of the body 410, and have a larger diameter than the body 410.

The second locking portion 430 may be formed at a second end portion of the body 410, and at least partially have a larger diameter than the body 410. For example, the second locking portion 430 may be formed corresponding to the first locking portion 420.

The coupling hole 313 of the sliding block 310 may include a first coupling hole 314 and a second coupling hole 315.

The first coupling hole 314 may have a first hole 316a and a second hole 317. The first hole 316a may be formed to have a diameter corresponding to the diameter of the body 410, and the second hole 317 may be formed for locking the first locking portion 420 therein.

The second coupling hole 315 may have a first hole 316b and a third hole 318. The first hole 316b may be formed to have a diameter corresponding to the diameter of the body 410, and the third hole 318 may be formed for locking the second locking portion 430 therein. In result, the first holes 316a and 316b may be formed to have larger diameters than the second hole 317 and the third hole 318, respectively.

The first coupling hole 314 and the second coupling hole 315 may form a pair between the neighboring picker units. That is, referring to FIG. 6, a left picker unit 300a has the second coupling hole 315 formed more inside than the first coupling hole 314, and a middle picker unit 300b also has a first coupling hole 314a formed more inside than a second coupling hole 315a, thereby making the first coupling hole 314a of the middle picker unit 300b form a pair with the second coupling hole 315 of the left picker unit 300a. Further, a second locking portion 430a of a connecting unit 400a is locked in the third hole 318 of the second coupling hole 315 of the left picker unit 300a, and a first locking portion 420a of the connecting unit 400a is locked in a second hole 317a of the first coupling hole 314a of the middle picker unit 300b, so that the left picker unit 300a and the middle picker unit 300b can be coupled by the connecting unit 400a.

Likewise, a right picker unit 300c has a first coupling hole 314b formed more outside than a second coupling hole 315b and forming a pair with the second coupling hole 315a of the middle picker unit 300b. Further, a second locking portion 430b of a connecting unit 400b is locked in a third hole 318a of the second coupling hole 315a of the middle picker unit 300b, and a first locking portion 420b of the connecting unit 400b is locked in a second hole 317b of the first coupling hole 314b of the right picker unit 300c so that the middle picker unit 300b and the right picker unit 300c can be coupled by the connecting unit 400b.

If the left picker unit 300a moves in a rightward direction, the second locking portion 430a and the first locking portion 420a of the connecting unit 400a for connection between the left picker unit 300a and the middle picker unit 300b are respectively moved into the third hole 318 of the left picker unit 300a and a second hole 317a of the middle picker unit 300b, thereby making the left picker unit 300a be in close contact with the middle picker unit 300b. In addition, the second locking portion 430b and the first locking portion 420b of the connecting unit 400b for connection between the middle picker unit 300b and the right picker unit 300c are also respectively moved into the third hole 318a of the middle picker unit 300b and the second hole 317b of the right picker unit 300c, thereby making the middle picker unit 300b be in close contact with the right picker unit 300c. In this manner, if the left picker unit 300a moves in the rightward direction, the left picker unit 300a, the middle picker unit 300b and the right picker unit 300c are in close contact with each other.

On the other hand, if the left picker unit 300a moves in a leftward direction in the state that the left picker unit 300a, the middle picker unit 300b and the right picker unit 300c are in close contact with each other, the second locking portion 430a of the connecting unit 400a for connection between the left picker unit 300a and the middle picker unit 300b moves leftward together with the left picker unit 300a while being locked in the third hole 318 of the left picker unit 300a. Then, the middle picker unit 300b also moves leftward as the first locking portion 420a is locked in the second hole 317a of the middle picker unit 300b. Further, the left picker unit 300a continues to move in the leftward direction, the second locking portion 430b of the connecting unit 400b for connection between the middle picker unit 300b and the right picker unit 300c moves leftward while being locked in the third hole 318a of the middle picker unit 300b. Then, the first locking portion 420b is locked in the second hole 317b of the right picker unit 300c, thereby moving the right picker unit 300c leftward.

Here, spaces between the respective picker units 300a, 300b and 300c may be restricted by the connecting unit for connection between the neighboring picker units. That is, the left picker unit 300a and the middle picker unit 300b may be restricted not to go beyond a preset reference space by the connecting unit 400a, and the middle picker unit 300b and the right picker unit 300c may be restricted not to go beyond a preset reference space by the connecting unit 400b.

The reference space may be restricted by the length of the body 410 of the connecting unit 400, and the length of the body 410 may be properly designed in accordance with a desired reference space.

Like this, the plurality of picker units 300 are all connected to their neighboring picket units by the connecting units 400 and move close to or away from each other, in which the space between the neighboring picker units may be restricted not to go beyond the preset reference space.

By the way, the connecting unit 400 may include a first connector having the body 410 and the first locking portion 420, and a second connector having an inserted portion inserted in the body 410 of the first connector and the second locking portion 430. That is, the connecting unit 400 may include the first connector and the second connector. The first connector may be inserted in a direction from the second hole 317 of the first coupling hole 314 toward the first hole 316a, and the second connector may be inserted in a direction from the third hole 318 of the second coupling hole 315 of the neighboring picker unit toward the first hole 316b. In the state that the first connector and the second connector are respectively inserted in the first coupling hole 314 and the second coupling hole 315, the inserted portion of the second connector is inserted in the body 410 of the first connector. Thus, the connecting unit 400 can connect the neighboring picker units with each other.

Below, in the lengthwise direction of the main rail 200, a direction of making the picker units 300 move close to each other will be called a first direction D1, and a direction of making the closed picker units 300 move away from each other, i.e. a counter direction to the first direction D1 will be called the second direction D2. In the accompanying drawings, the first direction D1 may be a rightward direction, and the second direction D2 may be the leftward direction.

The picker unit 300 may further include a stopper 360. The stopper 360 may be provided in the flange 312, and has a first stopping portion 361 and a second stopping portion 365.

The first stopping portion 361 may include a pin member 362. The pin member 362 may be extended in the lengthwise direction of the main rail 200. The pin member 362 may have a first end portion 363 protruding in a direction toward a front surface 319a of the sliding block 310, i.e. in the first direction D1.

The second stopping portion 365 may be provided at a lower side of the first stopping portion 361, and extended in the lengthwise direction of the main rail 200. The second stopping portion 365 may protrude in a direction toward a rear surface 319b of the sliding block 310, i.e. in the second direction D2.

The stopper 360 may adjust a stationary position between the neighboring picker units. Referring to FIG. 4, if the left picker unit 300a moves in the first direction D1, a first end portion 363a of a pin member 362a of a first stopping portion 361a provided in the left picker unit 300a may reach a stopping surface 366 of the second stopping portion 365 provided in the right picker unit 300b. Thus, it is possible to adjust the stationary position of the left picker unit 300a with respect to the right picker unit 300b, and thus adjust the space between the left picker unit 300a and the right picker unit 300b.

Further, the positions of the first stopping portion 361 and the second stopping portion 365 may be alternated up and down with each other according to the neighboring picker units. Thus, the first end portion 363 of the pin member 362 can be in close contact with the stopping surface 366 of the second stopping portion 365 provided in the picker unit neighboring in the first direction D1.

The protruding extent of the first end portion 363 of the pin member 362 and the protruding extent of the stopping surface 366 of the second stopping portion 365 may be properly adjusted according to preset stationary positions of the picker units, that is, a preset stationary space between the picker units 300. Ultimately, the stationary space between the picker units 300 may be properly adjusted according the size of the solar panel 10 to be fed.

The picker unit 300 may include a stationary picker unit 301, a driving picker unit 302 and a feeding picker unit 303.

The stationary picker unit 301 may be provided at an outermost side in the first direction D1. The stationary picker unit 301 may have a stationary portion 304, and the stationary portion 304 may be fastened to the main rail 200. Thus, the stationary picker unit 301 may be fixed to and not movable in the main rail 200.

The driving picker unit 302 may be provided at an outermost side in the second direction D2.

Further, the feeding picker unit 303 may be provided in between the stationary picker unit 301 and the driving picker unit 302.

The stationary picker unit 301, the driving picker unit 302 and the feeding picker unit 303 may have the sliding block 310, the cylinder 320, the vertical tube 330, the supporting block 340, the suction section 350 and the stopper 360 as described above, and be connected by the connecting unit 400.

The lower end portions of the suction sections 350 of the respective picker units may be different in height as much as the thickness t of the solar panel 10 to be sucked. Referring to FIG. 3, each lower end portion of the suction sections 350a, 350b, 350c and 350d holding the solar panel 10 may be shifted down as much as the thickness t of the solar panel 10 along the first direction D1.

Thus, when the respective picker units 300 are completely moved in the first direction D1, the opposite end portions of the neighboring solar panels 10 may be overlapped with each other. At this time, adhesive may be applied to the opposite end portions of the solar panel 10 sucked by the picker unit 300, and therefore the respective solar panels 10 may be adhered and connected to each other.

The adjusting unit 500 may include a first slider 510, a second slider 520, a rod 530 and a connecting frame 540.

The first slider 510 may be provided on the main rail 200 and reciprocate along the lengthwise direction of the main rail 200.

The second slider 520 may be provided on the main rail 200, spaced apart from the first slider 510 in the first direction D1, and reciprocate along the lengthwise direction of the main rail 200.

The rod 530 may connect the first slider 510 and the second slider 520. The first slider 510, the second slider 520 and the rod 530 may be moved as a single body.

The connecting frame 540 may be provided to connect the first slider 510 and the driving picker unit 302. Thus, the driving picker unit 302 interlocks with the first slider 510 and moves together with the first slider 510 when the first slider 510 moves.

The adjusting unit 500 makes the picker unit 300 move in the lengthwise direction of the main rail 200 while reciprocating in the lengthwise direction of the main rail 200, and thus adjusts a space between the picker units 300.

That is, if the adjusting unit 500 moves in the first direction D1, the driving picker unit 302 interlocking with the adjusting unit 500 moves in the first direction D1 and thus presses the feeding picker unit 303 to be in close contact with the first direction D1. The feeding picker unit 303 moving in the first direction D1 is stopped by the stationary picker unit 301. At this time, as described above, the solar panels 10 may be overlapped with each other at their opposite end portions.

The rod 530 may have a length within which all the picker units 300 are in close contact with each other when the second slider 520 is completely moved in the first direction D1.

Alternatively, the second slider 520 may be locked on the mail rail 200, and the first slider 510 may slide along the rod 530 arranged in the lengthwise direction of the main rail 200.

In this case, if the first slider 510 moves in the first direction D1 along the rod 530, the driving picker unit 302 interlocking with the first slider 510 moves in the first direction D1, and thus the feeding picker units 303 come in close contact with each other in the first direction D1. The feeding picker units 303 are moved in the first direction D1 and stopped by the stationary picker unit 301. At this time, the solar panel s10 may be overlapped with each other at the opposite end portions as described above, when the first slider 510 is in close contact with the second slider 520.

The first slider 510 may couple with the rod 530 so that the plurality of picker units 300 are all in close contact with each other when the first slider 510 moves in the first direction D1 and comes in close contact with the second slider 520. The initial position of the first slider 510, i.e. the maximum space between the first slider 510 and the second slider 520 may be varied depending on the number of picker units 300, the overlapped width between the solar panels 10, etc. Thus, when the first slider 510 is entirely moved in the first direction D1, the picker units 300 are all in close contact with each other.

Further, the driving picker unit 302 interlocking with the adjusting unit 500 moves in the second direction D2 and pulls the feeding picker units 303 to be moved in the second direction D2 and spaced apart from each other at preset reference intervals.

The foregoing embodiments are only for illustrative purpose, and it will be understood by a person having ordinary skill in the art that changes may be readily made in these embodiments without modifying technical ideas or necessary features. Therefore, the foregoing embodiments should not be construed as limiting the scope of the invention. For example, each element described as a single form may be separated, and the elements described as a discrete form may be also combined.

The scope of the invention is defined in the appended claims, and all changes or modifications from the meaning and spirits of the claims and their equivalents should be also construed as being included in the scope of the invention.

According to an embodiment of the present invention, the plurality of picker units is provided to hold and feed multiple solar panels at a time, thereby increasing productivity.

According to an embodiment of the present invention, the suction sections of the plurality of picker units are different in height so that the solar panels to be sucked can be also different in height, thereby facilitating an adhesive process for the respective solar panels.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An apparatus for feeding a solar panel, comprising:
a picker section which holds a plurality of solar panels;
a first feeding section which makes the picker section reciprocate in a vertical direction; and
a second feeding section which makes the picker section reciprocate in a horizontal direction,
the picker section comprising:
a main rail arranged in the horizontal direction;
a plurality of picker units provided under the main rail, reciprocating in a lengthwise direction of the main rail, and holding and moving corresponding solar panels at a time;
a connecting unit connecting neighboring picker units among the picker units, and restricting a space between the neighboring picker units not to go beyond a preset reference space; and
an adjusting unit provided on the main rail to make the picker units move in the lengthwise direction of the main rail and adjust a space between the picker units.

2. The apparatus for feeding the solar panel according to claim 1, wherein the picker unit comprises:
a sliding block which is slidably coupled to a lower portion of the main rail, has a plurality of coupling holes formed in the lengthwise direction of the main rail, and comprises flanges protruding at opposite end portions;
a cylinder which is placed at the opposite side end portions of the sliding block and provides vacuum pressure;
a vertical tube which connects with the cylinder, is extended downward in a vertical direction, and forms a passage through which the vacuum pressure is transferred;
a supporting block which is placed under the sliding block, connects the vertical tubes and internally formed with a passage through which the vacuum pressure from the vertical tube is transferred; and
a suction section which is placed in a lower portion of the supporting block and holds the solar panel with the vacuum pressure transferred from the supporting block.

3. The apparatus for feeding the solar panel according to claim 2, wherein the picker unit further comprises a stopper provided in the flange and adjusting a stationary position between the neighboring picker units.

4. The apparatus for feeding the solar panel according to claim 3, wherein the stopper comprises:
a first stopping portion which comprises a pin member extended in the lengthwise direction of the main rail and having a first end portion protruding in a direction toward a front surface of the sliding block; and
a second stopping portion which is provided at a lower side of the first stopping portion, extended in the lengthwise direction of the main rail and protruding in a direction toward a rear surface of the sliding block.

5. The apparatus for feeding the solar panel according to claim 4, wherein the first stopping portion and the second stopping portion may be alternated up and down with each other according to the neighboring picker units so that the first end portion of the pin member can be in close contact with the second stopping portion provided in the neighboring picker unit.

6. The apparatus for feeding the solar panel according to claim 2, wherein the connecting unit comprises:
a body having a length to restrict the reference space, and inserted in the coupling holes of the neighboring picker units;
a first locking portion formed at a first end portion of the body and having a larger diameter than the body;
a second locking portion formed at a second end portion of the body and at least partially having a larger diameter than the body.

7. The apparatus for feeding the solar panel according to claim 6, wherein the coupling hole comprises:
a first coupling hole having a first hole having a diameter corresponding to the diameter of the body, and a second hole formed for locking the first locking portion therein; and
a second coupling hole having the first hole and a third hole formed for locking the second locking portion therein, and
the first coupling hole and the second coupling hole may form a pair between the neighboring picker units.

8. The apparatus for feeding the solar panel according to claim 2, wherein the lower end portions of the respective suction sections are different in height as much as thickness of the solar panel to be sucked, so that the opposite end portions of the neighboring solar panels can be overlapped with each other when the picker units holding the solar panels move in a first direction along the lengthwise direction of the main rail and come in close contact with each other.

9. The apparatus for feeding the solar panel according to claim 8, wherein each lower end portion of the suction sections of the respective picker units is shifted down as much as the thickness of the solar panel along the first direction.

10. The apparatus for feeding the solar panel according to claim 2, wherein the picker unit comprises:
a stationary picker unit provided at an outermost side in the first direction in which the picker units holding the solar panels move to come in close contact with each other, and fixed to the main rail;
a driving picker unit provided at an outermost side in a second direction counter to the first direction; and
a feeding picker unit provided in between the stationary picker unit and the driving picker unit, and
the driving picker unit presses the feeding picker units to come in close contact with each other in the first direction while moving in the first direction, and pulls the close feeding picker units to be spaced apart from each other as much as the reference space while moving in the second direction.

11. The apparatus for feeding the solar panel according to claim 10, wherein the adjusting unit comprises:
a first slider provided on the main rail and reciprocating along the lengthwise direction of the main rail;
a second slider provided on the main rail, spaced apart from the first slider, and reciprocate along the lengthwise direction of the main rail;
a rod connecting the first slider and the second slider; and
a connecting frame connecting with the first slider and the driving picker unit so that the driving picker unit interlocking with the first slider moves when the first slider moves.

12. The apparatus for feeding the solar panel according to claim 11, wherein the rod is formed to have a length within which the plurality of picker units are all in close contact with each other when the second slider is completely moved in the first direction.

13. The apparatus for feeding the solar panel according to claim 10, wherein the adjusting unit comprises:
a first slider provided on the main rail;
a second slider provided on the main rail and spaced apart from the first slider;
a rod coupling with the second slider and arranged in the lengthwise direction of the main rail; and
a connecting frame connecting with the first slider and the driving picker unit so that the driving picker unit interlocking with the first slider moves when the first slider moves along the rod.

14. The apparatus for feeding the solar panel according to claim 13, wherein the first slider couples with the rod so that the plurality of picker units can be all in close contact with each other when the first slider moves in the first direction and comes in close contact with the second slider.
